(19) United States
(12) Patent Application Publication
(10) Pub. No.: US 2015/0194915 A1
(43) Pub. Date: Jul. 9, 2015

(54) H-BRIDGE SHOOT-THROUGH AVOIDANCE

(71) Applicant: MakerBot Industries, LLC, Brooklyn, NY (US)

(72) Inventor: Harry Elliot Mulliken, Hamilton, NJ (US)

(73) Assignee: MakerBot Industries, LLC, Brooklyn, NY (US)

(21) Appl. No.: 14/147,570

(22) Filed: Jan. 5, 2014

(51) Int. Cl. H02P 6/08

(52) U.S. Cl. CPC H02P 6/085

(57) ABSTRACT

An h-bridge uses a diode or other level shifter between the gates of two transistors in series. The level shifter enforces a sufficient voltage separation between the gates to ensure that both transistors cannot be turned on at the same time. In addition to mitigating cross-conduction during switching, the disclosed circuit makes it possible to control the four gates of an h-bridge with two control signals.

### FIELD OF THE INVENTION

This document generally relates to an h-bridge circuit, and more particularly an h-bridge circuit that avoids shoot-through during switching.

### BACKGROUND

An h-bridge is an electronic circuit that enables a voltage from a power source to be applied across a load in either direction. H-bridges are used in a variety of applications to bi-directionally power motors and the like. A bipolar stepper motor, for example, is commonly driven by a pair of h-bridges that drive complementary phases of the motor. The h-bridge provides a relatively simple architecture for alternatively driving terminals of a motor with forward and reverse current. However, a conventional h-bridge includes two pairs of transistors in series between a voltage source and ground, presenting a risk of “shoot-through”—a condition where two transistors in series are turned on at the same time resulting in a short circuit between the voltage source and ground—if control signals to the h-bridge are not carefully timed.

There remains a need for an improved h-bridge circuit that avoids shoot-through and mitigates the need for precise control timing.

### SUMMARY

An h-bridge uses a diode or other level shifter between the gates of two transistors in series. The level shifter enforces a sufficient voltage separation between the gates to ensure that both transistors cannot be turned on at the same time. In addition to mitigating cross-conduction during switching, the disclosed circuit makes it possible to control the four gates of an h-bridge with two control signals.

In one aspect, there is disclosed herein a device including an h-bridge comprising four transistors including a first transistor having a first gate, a second transistor having a second gate, a third transistor having a third gate, and a fourth transistor having a fourth gate, wherein the first transistor is coupled in series with the second transistor at a node that provides a first motor contact and wherein the third transistor is coupled in series with the fourth transistor at a second node that provides a second motor contact. A first level shifter having a first terminal and a second terminal couples the first gate to the second gate, the first level shifter including a first diode having an operating region wherein the first diode prevents current flow between the first terminal and the second terminal until a first voltage across the first terminal and the second terminal exceeds a first predetermined threshold and wherein the first diode prevents the first voltage from exceeding the first predetermined threshold. A second level shifter having a third terminal and a fourth terminal couples the third gate to the fourth gate, the second level shifter including a second diode having an operating region wherein the second diode prevents current flow between the third terminal and the fourth terminal until a second voltage across the third terminal and the fourth terminal exceeds a second predetermined threshold and the wherein the second diode prevents the second voltage from exceeding the second predetermined threshold.

### BRIEF DESCRIPTION OF THE DRAWINGS

The foregoing and other objects, features and advantages of the invention will be apparent from the following description of particular embodiments thereof, as illustrated in the accompanying drawings. The drawings are not necessarily to scale, emphasis instead being placed upon illustrating the principles of the devices and methods described herein.

FIG. 1 is a block diagram of an h-bridge configured to drive a stepper motor.

FIG. 2 is a circuit diagram of an h-bridge circuit.

FIG. 3 is a circuit diagram of an h-bridge drive circuit.

FIG. 4 is a circuit diagram of a current limiter for use in an h-bridge drive circuit.

### DETAILED DESCRIPTION

The embodiments will now be described more fully hereinafter with reference to the accompanying figures, in which preferred embodiments are shown. The foregoing may, however, be embodied in many different forms and should not be construed as limited to the illustrated embodiments set forth herein. Rather, these illustrated embodiments are provided so that this disclosure will convey the scope to those skilled in the art.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples, or exemplary language (“e.g.,” “such as,” or the like) provided herein, is intended merely to better illuminate the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “side,” “front,” “back,” and the like, are words of convenience and are not to be construed as limiting terms.

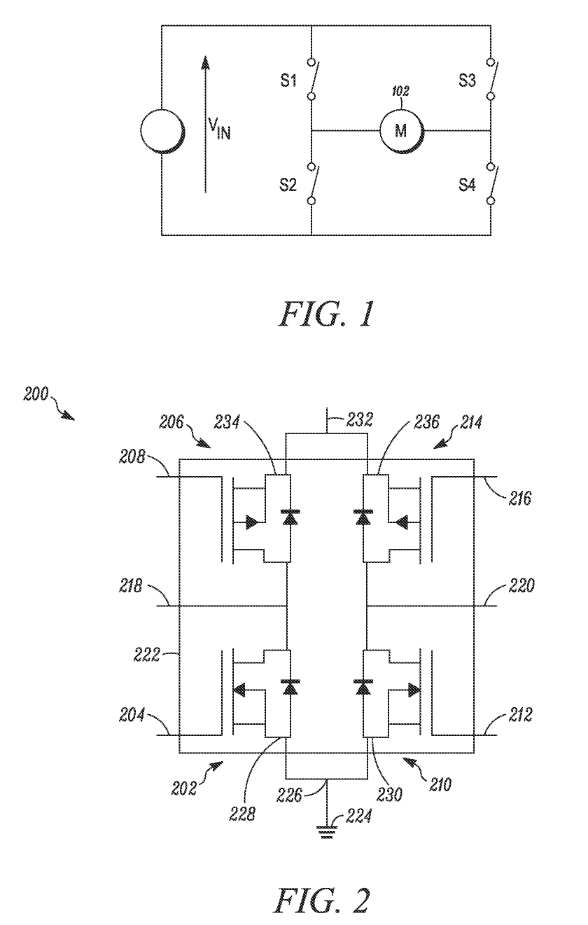

FIG. 1 is a block diagram of an h-bridge configured to drive a stepper motor. In general, two pairs of switches (generally, transistors) in series between the power rails of a voltage source, Vᵢₙ are arranged with two center nodes coupled across the terminals of a motor, M (also labeled as motor 102). In this configuration, the motor may be driven forward or backward by closing switches accordingly. For example, by closing switches S1 and S4, a positive voltage can be applied to the motor so that the motor rotates forward. Similarly, by opening switches S1 and S4 and closing switches S2 and S3, a negative voltage can be applied to the same motor terminals so that the motor rotates backward. Other switch settings may be used to brake or free wheel the motor as desired. For a stepper motor such as a bipolar stepper motor, a second h-bridge may be provided for the terminals of a second phase of the stepper motor, and the motor may be moved forward or backward in discrete increments by controlling the switches of the two h-bridges.

The motor 102 may, for example, be a stepper motor such as a bipolar stepper motor, with the h-bridge coupled to the leads on one phase of the motor. The use of h-bridges to drive stepper motors is well known in the art, and further details are not needed here, except to note that one of the difficulties of using h-bridges is the shoot-through of current from power to ground if, for example, switches S1 and S2 are closed at the same time. In the best of cases, this may simply result in wasted power and heat. In worse cases, this may result in circuit damage or failure. Thus when the switches S1-S4 are non-ideal transistors with finite switching times, careful timing of control signals is typically required to avoid shoot-through.

FIG. 2 is a circuit diagram of an h-bridge. In general, the h-bridge 200 may have four transistors including a first transistor 202 with a first gate 204, a second transistor 206 with a second gate 208, a third transistor 210 with a third gate 212, and a fourth transistor 214 with a fourth gate 216. The first transistor 202 may be coupled in series with the second transistor 206 at a first node 218 that provides a first motor contact. The third transistor 210 may be coupled in series with the fourth transistor 214 at a second node 220 that provides a second motor contact.

In general, the h-bridge 200 may be formed of discrete components on a printed circuit board or the like, or the h-bridge 200 may be packaged on a single chip and/or in a single semiconductor package 222 with leads extending from the package for the motor contacts (218, 220), gates (204, 208, 212, 216), power, and ground (which may be provided as separate leads for each half of the h-bridge, or as a single shared lead for each of power and ground).

A variety of transistors may be used as the transistors in the h-bridge 200 such as Bipolar Junction Transistors (BJTs), Field Effect Transistors (FETs), Metal Oxide Semiconductor Field Effect Transistors (MOSFETs), and so forth. For example, the first transistor 202 and the third transistor 210 may be n-channel metal oxide semiconductor field effect transistors, and a ground 224 may be coupled to a ground node 226 of the h-bridge 200 formed by a junction of a first source 228 of the first transistor 202 and a third source 230 of the third transistor 210. In a complementary fashion, the second transistor 206 and the fourth transistor 214 may be p-channel metal oxide semiconductor field effect transistors, and the h-bridge 200 may include a power node 232 formed by a junction of a second source 234 of the second transistor 206 and a fourth source 236 of the fourth transistor 214.

A motor such as any of the motors described above may have leads coupled to the first node 218 and the second node 220. Multiple h-bridges may also be packaged in the single semiconductor package 222 to provide a compact device for use with four leads of a bipolar stepper motor or the like.

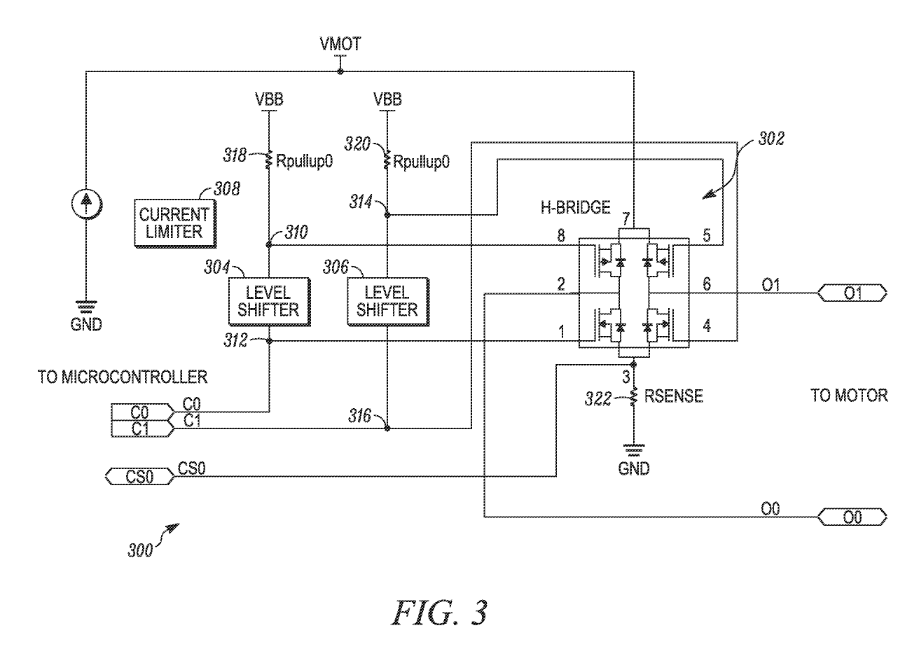

FIG. 3 is a circuit diagram of an h-bridge drive circuit. In general, the circuit 300 includes an h-bridge 302 such as any of the h-bridges described above, a first level shifter 304, a second level shifter 306, and a current limiter 308. By enforcing a voltage differential between the gate electrodes of in-series transistors, the level shifters prevent either pair of in-series transistors from being turned on simultaneously.

The first level shifter 304 may be a diode or the like having a first terminal 310 and a second terminal 312 coupling gates of two transistors in the h-bridge 302 as depicted in FIG. 3. In general, the diode may operate in a convention sense, having an operating region where the diode prevents current flow between the first terminal 310 and the second terminal 312 until a voltage across the terminals 310, 312 exceeds a predetermined threshold. At the same time, the diode prevents the voltage across the terminals 310, 312 from exceeding the predetermined threshold by providing effectively zero resistance to current flow for any voltage beyond the threshold. Of course, it will be understood that this describes an ideal diode, and that real diodes have variations to this ideal behavior. All such variations within the range of real diodes that might suitably be employed in the circuits described herein are intended to fall within the scope of this disclosure, and within the meaning of a diode or level shifter as those terms are used herein. For example, the first level shifter 304 may be a Zener diode or the like, and the predetermined threshold may be the breakdown voltage of the Zener diode.

The second level shifter 306 may be a diode or the like having a first terminal 314 and a second terminal 316 coupling gates of two other in-series transistors in the h-bridge 302 as depicted in FIG. 3. As with the diode of the first level shifter 304, this diode may operate in a convention sense, having an operating region where the diode prevents current flow between the first terminal 314 and the second terminal 316 until a voltage across the terminals 310, 312 exceeds a predetermined threshold. At the same time, the diode prevents the voltage across the terminals 314, 316 from exceeding the predetermined threshold by providing effectively zero resistance to current flow for any voltage beyond the threshold. Of course, it will be understood that this describes an ideal diode, and that real diodes have variations to this ideal behavior. All such variations within the range of real diodes that might suitably be employed in the circuits described herein are intended to fall within the scope of this disclosure, and within the meaning of a diode or level shifter as those terms are used herein. For example, the second level shifter 306 may be a Zener diode or the like, and the predetermined threshold may be the breakdown voltage of the Zener diode.

A pull-up resistor 318, 320 may be provided for each leg of the h-bridge 302. More specifically, each p-channel gate may be tied to a power rail through a pull-up resistor to float the gate high in the absence of an applied control signal. At the same time, each level shifter 304, 306 may be selected to ensure that an applied signal at the control inputs C0, C1 does not concurrently turn on the p-channel and n-channel transistors in one branch or leg of the h-bridge 302. In this manner, each leg may be independently controlled with a single control signal. Thus, for example, a first input for a control signal (C0) from a microcontroller or other control circuitry may be driven low to pull down (and turn on) the n-channel (ground side) transistor on one side of the h-bridge 302, while the first level shifter 304 ensures that the in-series p-channel (power side) transistor remain off. The first input may be floated or driven high to conversely turn on the p-channel transistor and turn off the n-channel transistor. Similarly, a second input for a second control signal (C1) from the microcontroller or other control circuitry may be driven low and high in a manner complementary to the first control signal (C0) so that the motor outputs (O1, O0), which may be coupled to a stepper motor or the like) are biased forward and reverse accordingly. In this manner, control signals may be applied to the h-bridge drive circuit 300 to drive a stepper motor.

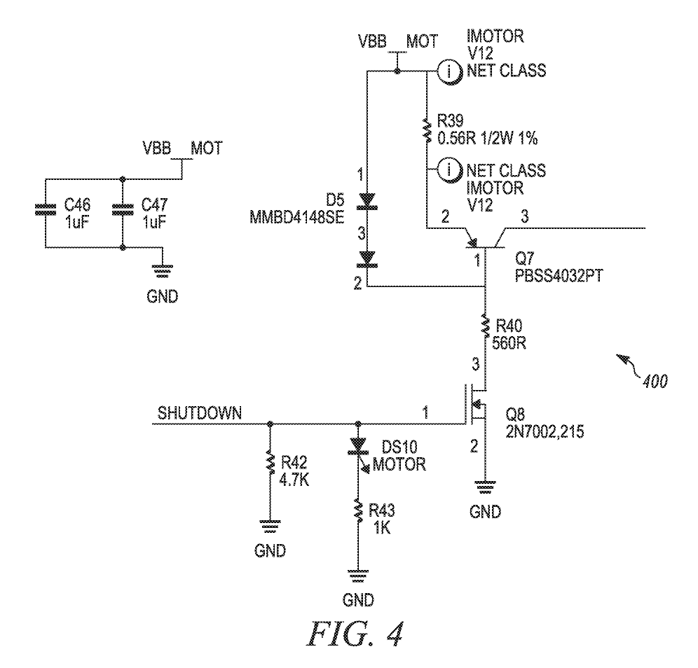

The current limiter 308 may be used to further mitigate shoot-through by limiting current that is sourced from a voltage/power source to the h-bridge 302. In general, the current limiter 308 may operate to prevent high current spikes that might otherwise result if the two control inputs (C1, C0) are alternated without sufficient intervening dead time. More generally, the current limiter 308 may be configured to provide power to the h-bridge 302 in a manner that limits the amount of current. The current limiter 308 may be the circuit described below with reference to FIG. 4, or more generally any current limited power source that might suitably be coupled to the power side of the h-bridge 302. The circuit 300 may also include a sense resistor 322 in series with a path to ground from the h-bridge 302, which may be used to sense current through the h-bridge 302, e.g., at a sensing node, CS0.

Some or all of the control circuitry depicted in FIG. 3, including the h-bridge 302, the level shifters 304, 306, the current limiter 308, and a microcontroller or the like, may be integrated on a single die or system-in-package within a single semiconductor package for use as a stepper motor controller.

FIG. 4 is a circuit diagram of a current limiter for use in an h-bridge drive circuit. In general, the current limiter 400 uses one or more diodes (D5) to enforce a voltage separation between a power source and the gate of a transistor (Q7). A resistor (R39) between the power source and the source of the transistor (Q7) has a voltage across it that will vary according to current passing through the transistor. When the current reaches a predetermined threshold, the voltage across the resistor (R39) will approach the voltage across the diode (D5) (after accounting for any diode(s) in the DC equivalent circuit for the transistor (Q7) and the transistor will begin to turn off, limiting further current flow therethrough. In this manner, current through the current limiter 400 provided to the h-bridge can be maintained at or below an amount controlled by the selection of a resistor, e.g., the resistor (R39), which can be used to tune the current limiter 400 according to any desired design specifications. A MOSFET (Q8) or other device may be used to turn the current-limited power source of the current limiter 400 on and off as desired through a control signal labeled as “SHUTDOWN.”

The above systems, devices, methods, processes, and the like may be realized in hardware, software, or any combination of these suitable for the control, data acquisition, and data processing described herein. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as the various systems described above, or all of the functionality may be integrated into a dedicated, standalone device. All such permutations and combinations are intended to fall within the scope of the present disclosure.

Embodiments disclosed herein may include computer program products comprising computer-executable code or computer-usable code that, when executing on one or more computing devices, performs any and/or all of the steps of the control systems described above. The code may be stored in a non-transitory fashion in a computer memory, which may be a memory from which the program executes (such as random access memory associated with a processor), or a storage device such as a disk drive, flash memory or any other optical, electromagnetic, magnetic, infrared or other device or combination of devices. In another aspect, any of the control systems described above may be embodied in any suitable transmission or propagation medium carrying computer-executable code and/or any inputs or outputs from same.

The method steps of the invention(s) described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as defined by the following claims, which are to be interpreted in the broadest sense allowable by law.

What is claimed is:

1. A device comprising:
an h-bridge comprising four transistors including a first transistor having a first gate, a second transistor having a second gate, a third transistor having a third gate, and a fourth transistor having a fourth gate, wherein the first transistor is coupled in series with the second transistor at a first node that provides a first motor contact and wherein the third transistor is coupled in series with the fourth transistor at a second node that provides a second motor contact;
a first level shifter having a first terminal and a second terminal coupling the first gate to the second gate, the first level shifter including a first diode having an operating region wherein the first diode prevents current flow between the first terminal and the second terminal until a first voltage across the first terminal and the second terminal exceeds a first predetermined threshold and wherein the first diode prevents the first voltage from exceeding the first predetermined threshold; and
a second level shifter having a third terminal and a fourth terminal coupling the third gate to the fourth gate, the second level shifter including a second diode having an operating region wherein the second diode prevents current flow between the third terminal and the fourth terminal until a second voltage across the third terminal and the fourth terminal exceeds a second predetermined threshold and the wherein the second diode prevents the second voltage from exceeding the second predetermined threshold.

2. The device of claim 1 wherein the first diode includes a Zener diode.

3. The device of claim 2 wherein the first predetermined threshold is a breakdown voltage of the Zener diode.

4. The device of claim 3 wherein the second diode includes a second Zener diode.

5. The device of claim 4 wherein the second predetermined threshold is a second breakdown voltage of the second Zener diode.

6. The device of claim 1 wherein each of the four transistors is a field effect transistor.

7. The device of claim 1 wherein each of the four transistors is a metal oxide semiconductor.

8. The device of claim 1 further comprising a second h-bridge with a third motor contact and a fourth motor contact, a third level shifter, and a fourth level shifter.

9. The device of claim 8 wherein the h-bridge and the second h-bridge are packaged in a semiconductor chip.

10. The device of claim 9 further comprising control circuitry for a stepper motor packaged in the semiconductor chip.

11. The device of claim 1 further comprising a motor coupled between the first motor contact and the second motor contact.

12. The device of claim 11 wherein the motor includes a stepper motor.

13. The device of claim 12 further comprising control circuitry to control a signal applied to a terminal of the first level shifter and the second level shifter in a manner configured to drive the stepper motor.

14. The device of claim 1 wherein the first transistor and the third transistor are n-channel metal oxide semiconductor field effect transistors, the device further comprising a ground coupled to a ground node of the h-bridge formed by a junction of a first source of the first transistor and a third source of the third transistor.

15. The device of claim 14 further comprising a sense resistor in series between the ground and the ground node.

16. The device of claim 14 wherein the second transistor and the fourth transistor are p-channel metal oxide semiconductor field effect transistors, the device further comprising a power node of the h-bridge formed by a junction of a second source of the second transistor and a fourth source of the fourth transistor.

17. The device of claim 16 further comprising a current limited power source coupled to the power node of the h-bridge.

18. The device of claim 17 comprising a first pull up resistor coupled between a second gate of the second transistor and a power rail, and further comprising a second pull up resistor between the fourth gate of the fourth transistor and the power rail.

19. The device of claim 18 wherein the first predetermined threshold for the first level shifter is selected to ensure that the first transistor and the second transistor are not turned on concurrently in response to a control signal applied to the first gate.

20. The device of claim 18 wherein the second predetermined threshold for the second level shifter is selected to ensure that the third transistor and the fourth transistor are not turned on concurrently in response to a control signal applied to the third gate.

21. The device of claim 1 further comprising a current limiter configured to provide power to the h-bridge.
